(19) United States
(12) Patent Application Publication
(10) Pub. No.: US 2007/0233672 A1
(43) Pub. Date: Oct. 4, 2007

(54) PERSONALIZING SEARCH RESULTS FROM SEARCH ENGINES

(75) Inventors: Marc SANFACON, St-Augustin-de-Desmaures (CA); Pascal SOUCY, Quebec (CA); Laurent SIMONEAU, St-Augustin-de-Desmaures (CA); Daniel LAVOIE, Quebec (CA); Michel LEMAY, Quebec (CA)

Correspondence Address: OGILVY RENAULT LLP, 1981 MCGILL COLLEGE AVENUE, SUITE 1600, MONTREAL, QC, H3A2Y3, CA

(73) Assignee: COVEO INC., Quebec (CA)

(21) Appl. No.: 11/694,360

(22) Filed: Mar. 30, 2007

Related U.S. Application Data
(60) Provisional application No. 60/787,177, filed on Mar. 30, 2006.

(51) Int. Cl. G06F 17/30

(52) U.S. Cl. 707/5

(57) ABSTRACT

A personalized search engine system and corresponding method which is used by an identified user for retrieving documents on a corporate network or intranet. The identified user being related to a unique personalization identifier (UPID) and to a list of group personalization identifiers (GPIDs). The system comprises a search engine interface for obtaining a query from the identified user; a search engine for finding documents matching the query; and a ranking engine for ranking the documents matching the query in order of relevancy, where the ranking is partly based on a previously calculated document rating for the UPID of the identified user, where the ranking is further based on a previously calculated document ratings for each of the GPIDs of the identified user.

### CROSS-REFERENCE TO RELATED APPLICATIONS

This application claims priority under 35US§119(e) of U.S. provisional patent application 60/787,177, filed on Mar. 30, 2006, the specification of which is hereby incorporated by reference.

### TECHNICAL FIELD

The present description relates to the field of information retrieval, and more particularly, to search engines such as those found on an intranet or in a corporate network.

### BACKGROUND

Computer networks are systems that connect two or more computers and peripheral devices in order to share resources and exchange information between them. For the purpose of the present description, a user is a person with defined rights to use or access these computers, devices, and information, and a group is a collection of users with some common access authorities on protected resources.

A search engine is a system that retrieves information from a database. In general, a search engine indexes documents on a computer network and generates a list of results following a search query. The list of results is ordered by a ranking algorithm whose function is to evaluate the relevance of each result relatively to the query. On most search engines, the result list produced is the same regardless of the user who submits the query.

Personalized search engines attempt to tailor the result list to an individual user's profile and preferences. Such a tailoring can be done, for instance, by taking into account explicit document relevance judgments by the user and recent document interactions (document access, document modification, etc.).

Despite reaching good ranking results, search engines limited to traditional rankings do not include user profiles in determining relevancy of results. Traditional rankings state that, for a given query and a given set of documents, the results are all equally relevant to all users, which is not always the case.

### SUMMARY

There is described a method and a related system for personalizing search results based on a social network representation of a community of users.

Social networks are social structures between people inside an organization or community such as a company.

Individuals are represented by nodes within the network, and relationships between individuals are represented as ties. While there can be several types of ties between the nodes, for the purpose of the present description, a tie is any type of relationship that can be measured by interactions between nodes.

Suppose a technology company ABC that designs wireless devices. The enterprise has salesmen, a marketing team, administrators and an R&D team. If the query submitted is “sales figures”, a salesperson might be looking for his personal sales for the month, a marketer might be searching for a report his team recently created to track sales by product versions and promotions while an administrator might be looking for the accountant report for the quarterly sales of the company. In every case, a better ranking of the matching documents may be provided by embedding the social network of the company in the model, knowing, for instance, that the finance officer is more likely to be looking for a report made by accountants than a market analysis document created by the marketing team.

With personalization, a search engine returns the most relevant results given a query for a specific user. Thus, personalized search engines attempt to tailor the result lists to individual user profiles and preferences. Collaborative personalization improves the personalization process by taking the preferences of close coworkers to influence the ranking of the search results of users.

According to an embodiment, there is provided a method to personalize search results on a search engine. The method comprises: providing a user interface; identifying a user accessing the user interface; associating (or assigning or relating) the identified user to a unique personalization identifier (UPID) and to a list of group personalization identifiers (GPIDs), where the GPIDs identify predefined groups of which the identified user is a member; displaying a search engine interface on the user interface; obtaining from the search interface a query from the user; sending the query to the search engine to find documents matching the query; ranking the documents matching the query in order of relevancy, where the ranking is partly based on previously calculated document ratings for the UPID of the identified user, where the ranking is further based on previously calculated document ratings for each of the GPIDs of the identified user; and displaying the ranked documents.

According to an embodiment, there is provided a search engine system to personalize search results. The search engine system comprises: a user interface for accessing by an identified user, the identified user being related to a unique personalization identifier (UPID) and to a list of group personalization identifiers (GPIDs), where the GPIDs identify predefined groups of which the identified user is a member; a search engine interface for displaying on the user interface and for obtaining a query from the identified user; a search engine for finding documents matching the query; and a ranking engine for ranking the documents matching the query in order of relevancy, where the ranking is partly based on previously calculated document ratings for the UPID of the identified user, where the ranking is further based on previously calculated document ratings for each of the GPIDs of the identified user. The user interface being further for displaying the ranked documents.

According to an embodiment, there is provided a system that analyzes a social network representation of users on a corporate network and creates groups of users; each user is identified by a unique personalization identifier (UPID) and can be a member of zero, one or many groups. Each group is also given a unique “group personalization identifier” (GPID). Documents from the computer network are then evaluated with respect to these PIDs; the evaluation comprises determining which documents are relevant to which PID in the social network, where such relations may be determined by the security rights that establish which user (or group of users) may read or modify the document content, the number of times a particular user (or group of users) accessed the document (“click-through data”), the list of users who authored the document, and document relevance assessments by users (or groups of users) and other personalization modifiers.

According to an embodiment, there is provided a personalized search engine for retrieving documents on a corporate network or intranet, comprising a search engine on which a user query is responded by a generated list of results ranked in order of relevance, where the ranking is partly based on the personalized prior relevancy of the documents for the UPID of this specific user, where the ranking is further modified by the personalized prior relevancy of the documents for the GPIDs of the groups of which the user is a member.

According to an embodiment, there is provided a software product stored on a recordable medium to interface with a search engine, the interface allowing a user to search documents, comprising: means for identifying the user and finding his UPID; means for submitting a query to the search engine; means for displaying a list of document information ordered by document scores, where the ranking is partly based on the personalized prior relevancy of the documents for the UPID of this specific user, and where the ranking is further modified by the personalized prior relevancy of the documents for the GPIDs of the groups of which the user is a member; means for the user to generate relevance data by explicitly assessing relevance of documents; means for compiling clicks through statistics; means to determine a global score of prior relevancy of a document for a particular user; and means to propagate in real time the explicit and implicit assessments of relevancy of documents for this user to the PIDs associated to this user.

According to an embodiment, there is provided a search engine system to perform social network-based personalized searches, comprising: a client-side system having a search engine interface, where the search engine interface allows users to generate relevance data by explicitly assessing relevance of documents and generate click-through statistics submitted to the search engine; a server-side system having a control program and data structures for storing document relevance assessments and click-through statistics, wherein the control program generates a result list according to the user's query, this list ordered by a ranking, this ranking comprising (but not limited to): the user click-through statistics and that of groups of which he is a member; relevance assessments previously made by the user and that of groups of which he is a member; other similar personalized score assigned to documents and that of groups of which he is a member.

According to an embodiment, there is provided a method to perform a social network-based personalized search, comprising the steps of: providing a client-side system having a search engine interface; identifying the user connected to the search engine and sending this information to the search engine; associating the user to his UPID and to his list of GPIDs, submitting a search query to the search engine; retrieving a search result list from a search index; ordering the result list by a ranking algorithm; refining the ranking of the result list using the explicit assessments of relevance by those PIDs; further refining the ranking using implicit assessments, where implicit assessments comprise the click-through statistics by the PIDs, and other relations between the PIDs and documents such as document authorship and security access rights.

### BRIEF DESCRIPTION OF THE DRAWINGS

Further features will become apparent from the following detailed description, taken in combination with the appended drawings, in which:

FIG. 1 is a diagram showing an example of a social network representation;

FIG. 2 is a diagram showing an example of a social network representation with groups as a result of social network learning;

FIG. 3 is a diagram showing an example of an organizational charts with groups;

FIG. 4 is a diagram illustrating a search engine system on a corporate network according to the prior art;

FIG. 5 is a diagram showing a search engine system on a corporate network according to an embodiment, the search engine including a personalized database;

FIG. 6 is schematic that illustrates a search interface according to an embodiment;

FIG. 7 is a diagram that illustrates the data structures which constitute the personalized database of FIG. 5;

FIG. 8 is a flowchart of the steps performed by the search engine during a query according to an embodiment;

FIG. 9 is a flowchart of the ranking process according to an embodiment;

FIG. 10 is a flowchart of the process of updating the automatic rating database according to an embodiment; and

FIG. 11 is a flowchart of the process of updating the manual rating database according to an embodiment.

It will be noted that throughout the appended drawings, like features are identified by like reference numerals.

### DETAILED DESCRIPTION

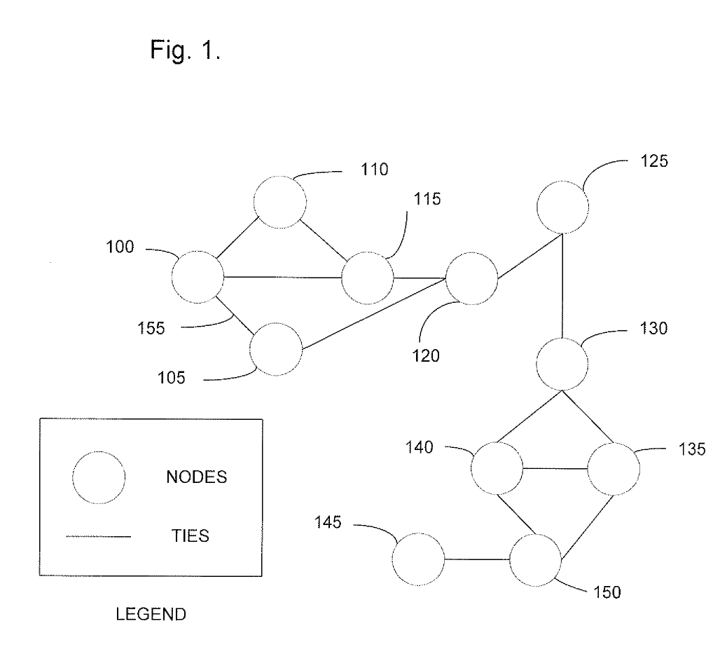

Referring to the figures, FIG. 1 shows an example of a social network. In FIG. 1, there are eleven nodes, numbered 100 to 150. Node 100 is connected to node 105 via tie 155. This tie represents an interaction between users represented by these nodes. Ties can be more or less strong. The strength of ties depends upon frequency of interaction between people and types of relationships. Social Network Analysis is the area of study of methods to measure relationships and flow between people, groups and organizations. Social networks are usually built manually by experts and conducted through surveys and analysis of organizational charts that provide explicit statements of relationships. Other techniques involve deriving social networks from implicit statements of relationships. For instance, automatic social networks can be built on the Web through the auction transactions on a site such as Ebay™. Other methods have focused on email flows.

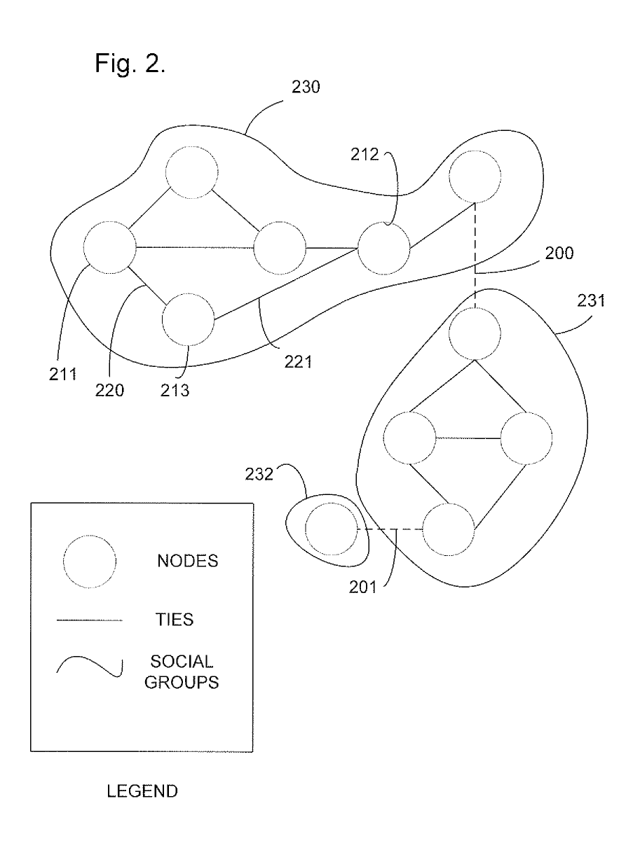

In one embodiment and still referring to the figures, FIG. 2 shows the result of a grouping process. This result is obtained by breaking weak ties in a social network. A threshold Thr is used. When the strength of the tie between a pair of nodes is less than Thr, the tie is broken, as shown by dotted lines 200 and 201 in the figure. After all ties are evaluated and weak ties are broken, all connected graphs from the social network are identified. According to graph theory, a connected graph is a graph where there is at least one path between each pair of nodes. For instance, between nodes 211 and 212, there is a path that goes from 211 to 213 through tie 220, then from 213 to 212 through tie 221. In FIG. 2, there are three connected subgraphs 230, 231 and 232. In this embodiment, a user is a member of one and only one group and each group is assigned a unique GPID.

In another embodiment, a social network is analyzed more thoroughly in order to generate clusters of nodes. A social network is a weighted connected graph. Using clustering algorithms (e.g. single-link, complete link or minimum spanning tree algorithms), it is possible to define clusters of nodes. In the present context, each cluster is then assigned a unique GPID. In this embodiment, a user can be a member of zero, one or many social groups, depending upon the clustering algorithm used to create groups.

In another embodiment, groups are taken from the operating system security groups and no social network is used. Just as the other embodiments described above, a security group is given a unique GPID. A user can be a member of zero, one or many security groups on a corporate network.

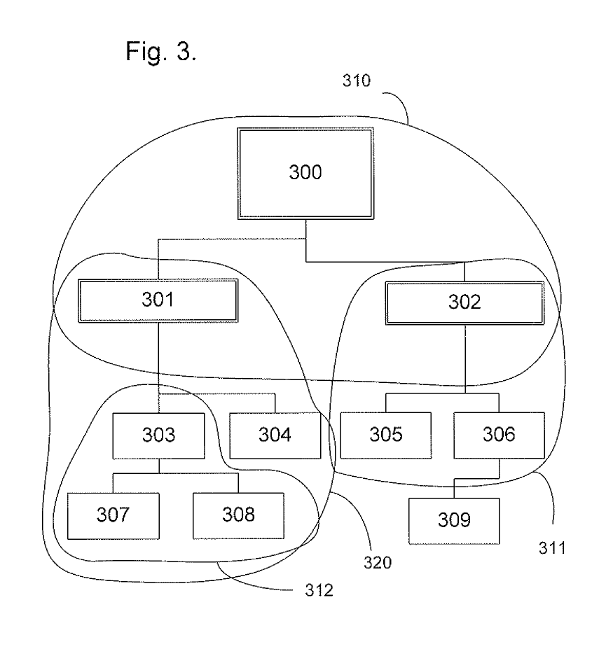

In yet another embodiment, the organizational chart may be used to define hierarchical groups. FIG. 3 shows an example of an organizational chart. An organizational chart is generally a tree. Under such a representation, leaves or members (for instance, 301 and 302) under a common root (for instance, 300) are generally coworkers, while the root is the team leader. Small groups can thus be formed using the leader and his staff. Labels 310, 311 and 312 are three examples of such groupings. Group 310 includes members 300, 301 and 302. Group 311 includes members 302, 305 and 306. Group 312 includes members 303, 307 and 308. Larger groups like 320 (which includes group 312 and member 304) may also be formed by combining more levels from the hierarchy. Member 309 is not a member of any hierarchical group. Bach group is assigned a unique GPID, and a user can be a member of zero, one or many hierarchical groups.

The illustrations so far show many ways by which users can be members of groups. Methods to define group membership can be used interchangeably. This description thus starts with groups of users and means to identify which user belongs to which group. In the general case, a user can be a member of zero, one or many groups.

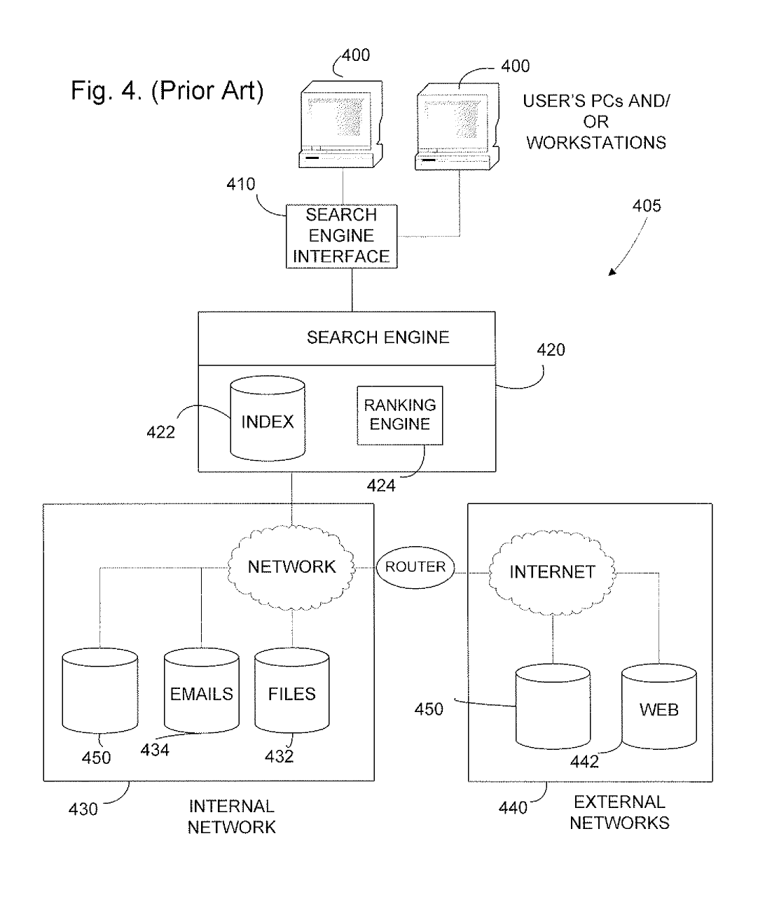

Still referring to the figures, FIG. 4 illustrates the functionality of a traditional search engine system 405 on a corporate network. A PC or Workstation 400 submits queries to a search engine 420 via a search engine interface 410. The search engine interface communicates data to the search engine 420. A search engine 420 takes the query submitted to the interface 410 by a user and consults an index (database) 422 to retrieve results. These results are then ordered by relevancy by a ranking engine 424. The ranking is influenced by many factors (number of occurrence of query terms in documents, for instance). This ranking is referred herein as “traditional ranking”. The index 422 is built by getting documents from many locations, which may comprise an internal network 430, where files 432 and emails 434 are stored, and an external network 440, where Web pages 442 are crawled. Documents from other databases 450 may also be retrieved.

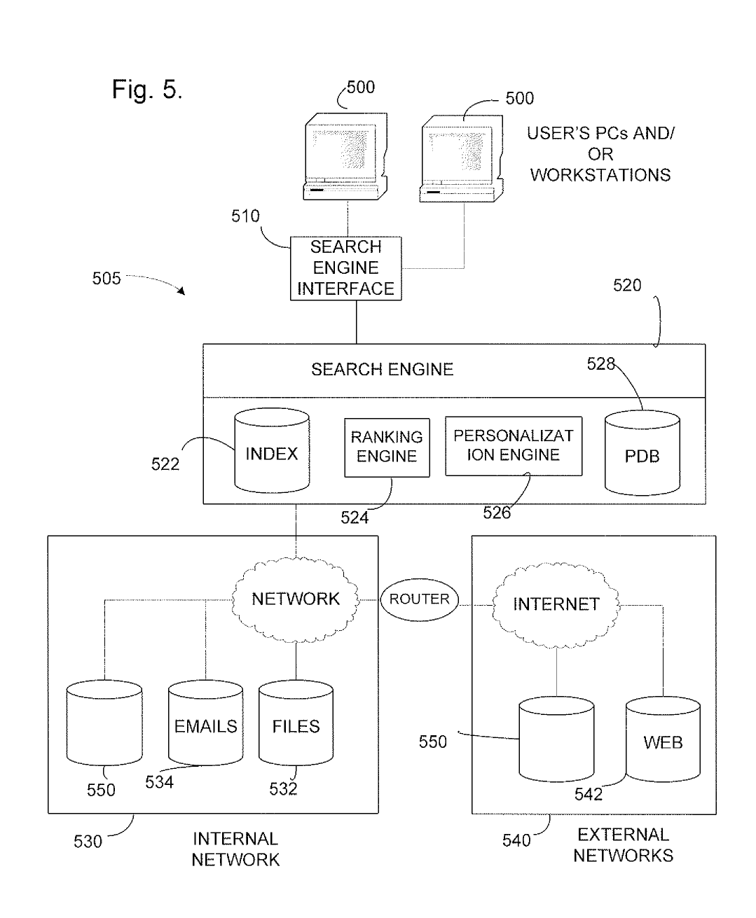

Still referring to the figures, FIG. 5 illustrates the search engine system 505 according to an embodiment, to which a personalization ranking module 526 is added. The personalization ranking module 526 uses a personalization database 528. The content of the personalization database 528 and the functionality of the personalization ranking module 526 are described below. The personalization ranking module 526 provides information relating the current user to the ranking engine module 524 in order to influence the ranking of the results.

A PC or Workstation 500 having a user interface (shown, but not labeled). A search engine interface 510, displayed on the user interface, is used to submit queries. The search engine interface 510 communicates data to the search engine 520. A search engine 520 takes the query submitted to the search engine interface 510 by a user and consults an index (database) 522 to retrieve results. These results are then ordered by relevancy by a ranking engine module 524. The ranking is influenced by many factors (number of occurrence of query terms in documents, for instance). This ranking is referred herein as “traditional ranking”. The index 522 is built by getting documents from many locations, which may comprise an internal network 530, where files 532 and emails 534 are stored, and an external network 540, where Web pages 542 are crawled. Documents from other databases 550 may also be retrieved.

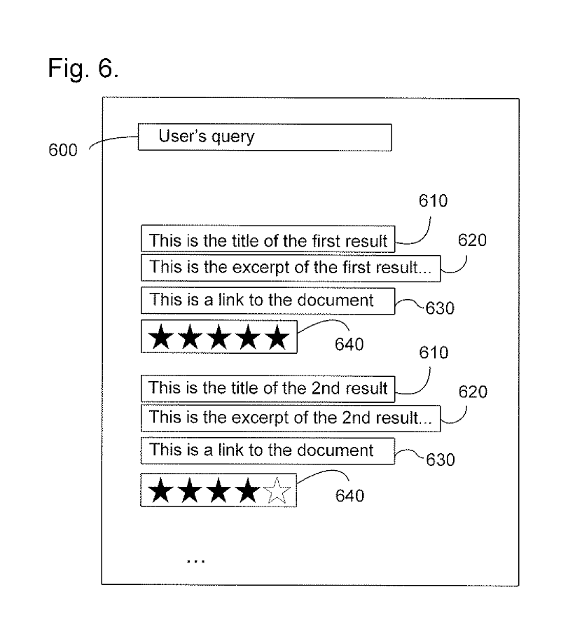

Still referring to the figures, FIG. 6 illustrates a search engine interface displayed to the user. The user may enter a query in a query box 600. Search results may comprise the document title 610, a document excerpt 620 and a link to the document 630. A manual rating mechanism 640 is also shown to the user. In this illustrative embodiment, the manual rating mechanism is by way of stars (e.g. the user clicks on the third star to get a three-stars rating, on the fifth star to get a five-stars rating, etc.). Other ways of allowing the user to rate results could be used as well, such as using a drop-down list of ratings, a text box or displaying an evaluation form. Click-through data is also collected at this time. Every time a user clicks on a link 630 to the document, this information is sent to the personalization ranking module 526 of FIG. 5.

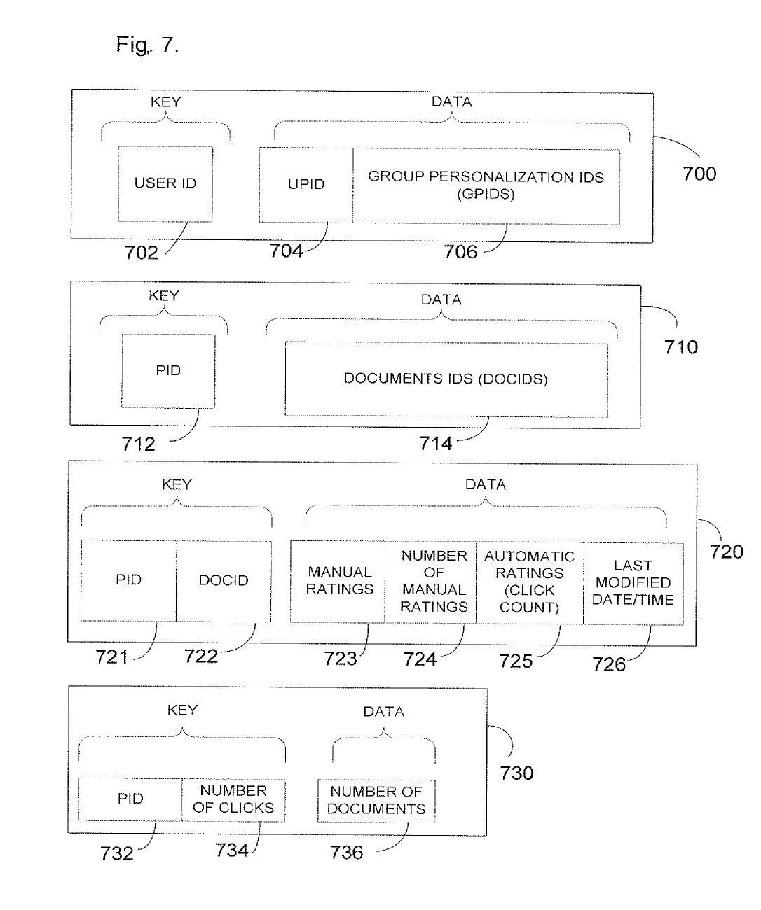

Again referring to the figures, FIG. 7 shows the data structures constituting the personalization database 528 from FIG. 5. The first structure 700 relates a user 702 to his Personalization Identifier 704 (UPID) and to a list of Group Personalization Identifiers (GPIDs) 706. This list comprises all groups of which the user is a member. The second structure 710 associates a PID 712 (UPID or GPID) with a list of document identifiers (DOCID) 714. This list contains all documents for which personalized information is available for a given PID. The third structure 720 combines each pair of PID 721 and DOCID 722 to store the personalization data. This data has four parts. The first value contain manual rating score 723. Manual rating refers to explicit assessments of document relevance by a PID, such as done using search interface shown in FIG. 6. The second value 724 contains the number of manual ratings done by users at any time. The third value 725 is the automatic rating of a document calculated from click-through statistics. The last value 726 contains the last date and time that one of the three other values was modified. Finally, the last structure 730 relates a PID 732 and a click level 734 (i.e., number of clicks or click count) for this PID. The data contained in bucket 736 is the number of documents that has been clicked that number of times.

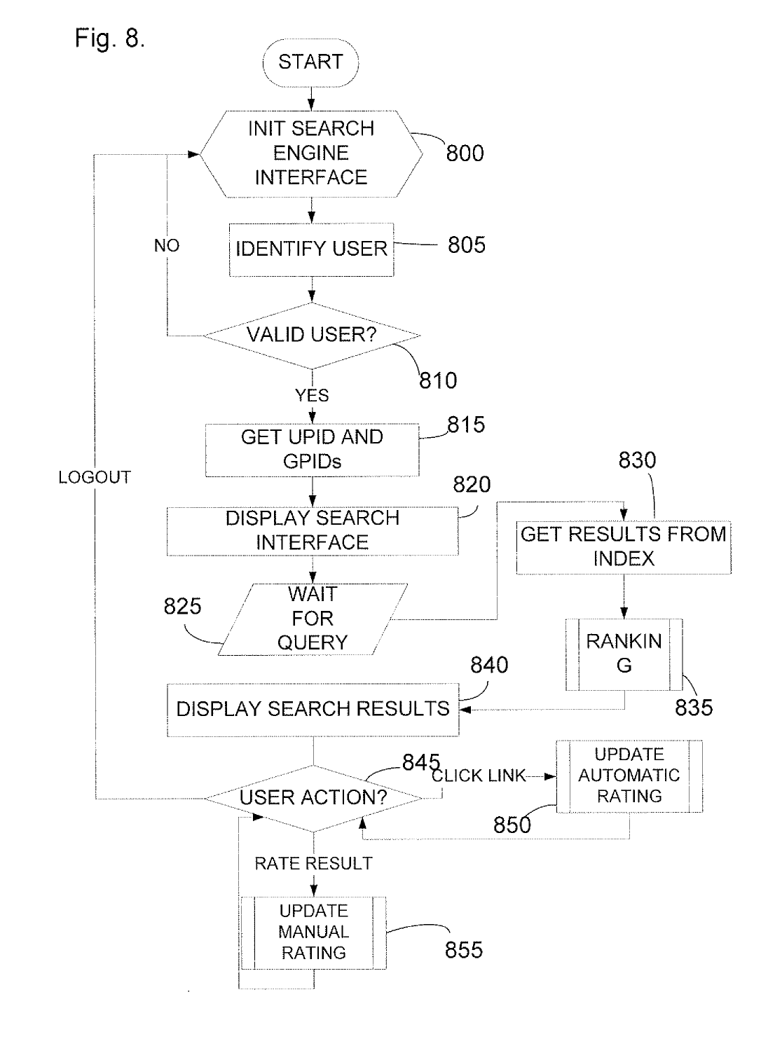

Turning to FIG. 8 and still referring to FIG. 5, FIG. 8 shows the steps performed by an illustrative embodiment of the search engine interface 510 to capture click-through data and manual ratings. At step 800, the search engine interface 510 is initialized after a user accesses the search engine interface 510 through a user interface provided to him. At step 805, a process identifies the user. This process can be done through a special login form (asking for a username and password) or via automatic authentication. Step 810 verifies whether the user is a valid user with rights to use the search engine. At 815, the user personalization identifier (UPID) is retrieved, along with a list of group personalization identifiers (GPIDs) of the groups of which the user is a member. A user is hence associated to a predefined UPID and a predefined list of GPIDs. At step 820, the search engine interface 510 is displayed. The interface waits at step 825 for the user to submit a query as input. The query is sent to the search engine 520 and results are then obtained from index at step 830, then ordered by a ranking process (described below) at step 835. The ranking is partly based on previously calculated document ratings for the UPID of the identified user. The ranking is further based on previously calculated document ratings for each of the GPIDs of the identified user. Finally, the ranking is displayed on the user interface at step 840. Afterwards, the search engine interface 510 waits at 845 for an action from the user. If a result link is clicked by a user, an Automatic Rating Update process 850 is executed (described below). If a result is manually rated, a Manual Rating Update 855 (described below) is executed.

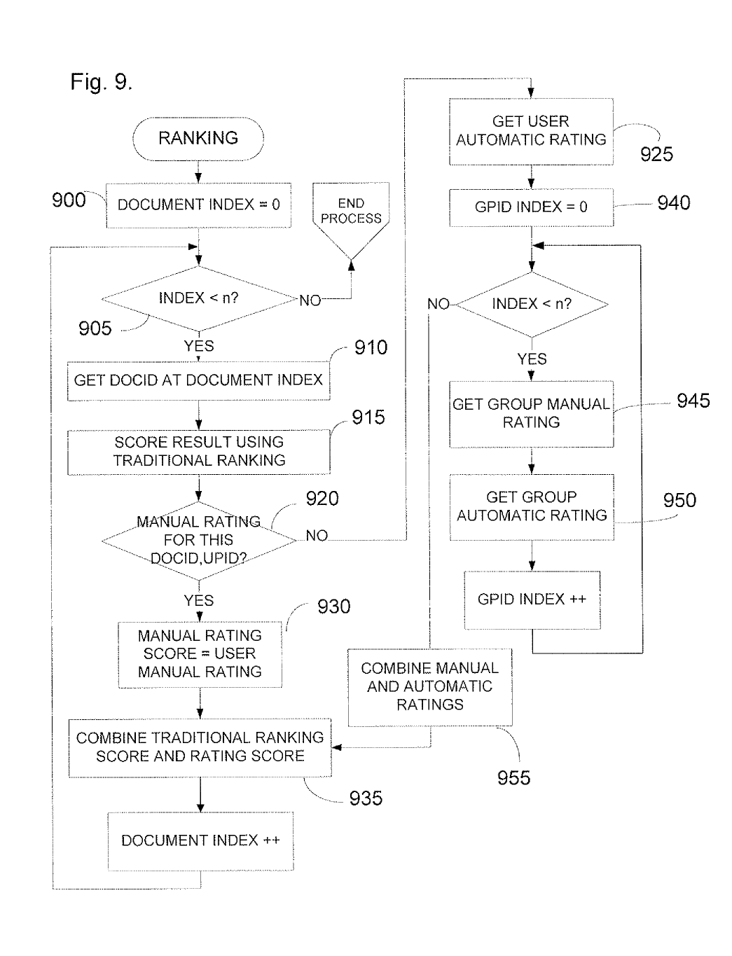

Still referring to the figures, FIG. 9 illustrates the Ranking process. For each document, a score is calculated, starting with the first result that matched the query at step 900. Step 905 verifies that there still are documents to evaluate. For the current result, the Document Identifier is obtained (DocID). As shown in the structure of FIG. 7, a combination of a PID (UPID or GPID) with a DocID gives access to a data structure containing personalization data. At step 915, a traditional ranking algorithm may be executed to provide a basis score. At step 920, a condition verifies whether the user has manually rated the result in the past. If it is not the case, the process branches to step 925, otherwise, it goes to step 930. Step 930 is executed when the user has manually rated the result. In this embodiment, user manual rating supersedes any automatic rating or group rating. The user manual rating is obtained and then, combined to the score of the traditional ranking at step 935. This combination is obtained by the following equation:
DocScore=TraditionalRankingScore*weightTrad+RatingScore*weightRating
where the TraditionalRankingScore is the score resulting from step 915, RatingScore is the score of the personalization rating mechanism, and weightTrad and weightRating are two configurable values to define the relative importance of Traditional Ranking and Rating in the final ranking.

In the case when the process went by branch “Yes” at step 920, the Rating Score is simply the manual rating value set by the user. If there was no Manual Rating for this user, the process branches to step 925 where the data structure of FIG. 7 is read to see if the user ever clicked a link to the result being evaluated. If it is the case, then the automatic rating for this UPID is calculated. If there is no automatic rating for this user, a default value is given for the user automatic rating. The automatic rating process works as follows.

The data structure 730 from FIG. 7 provides information about the number of documents for each click level. The following table provides an example:

| Click | Number of documents | Cumulative |
|---|---|---|
| level | in this level | clicks |
| 7 clicks | 1 | 7 |
| 6 clicks | 2 | 19 |
| 5 clicks | 3 | 34 |
| 4 clicks | 5 | 54 |
| 3 clicks | 8 | 73 |
| 2 clicks | 9 | 96 |
| 1 click | 23 | 119 |

Using this example, there would be a Bucket for this PID with 4 as the number of clicks and 5 as the number of documents. The third column of the table, the cumulative number of clicks, is calculated from the first two columns. Using the total number of clicks, 5 quartiles are defined. Each quartile is of a size

$$QuartileSize = ⌊ \frac{TotalClicks}{5} ⌋$$

since there are 5 possible rating values. Then, the five levels of rating are defined by increasing the value of the level by the amount of QuartileSize. The following table is the result for the previous example

| Cumulative | Rating (1 to 5, |
|---|---|
| level | 5 is best) |
| 0-23 | 5 |
| 24-47 | 4 |
| 48-71 | 3 |
| 72-95 | 2 |
| 96-119 | 1 |

Finally, for each given click level and the corresponding cumulative click count, the rating is assigned. The final rating for a given click level from the example is provided in the following table:

| Click | Cumulative | |
|---|---|---|
| level | clicks | Rating |
| 7 clicks | 7 | 5 |
| 6 clicks | 19 | 5 |
| 5 clicks | 34 | 4 |
| 4 clicks | 54 | 3 |
| 3 clicks | 78 | 2 |
| 2 clicks | 96 | 1 |
| 1 click | 119 | 1 |

Thus, a result that has been clicked 5 times would get a rating of 4. Documents that were never clicked get a rating of zero.

The result from this user automatic rating is kept in a variable, UserAutomaticRating.

Then, starting at step 940, for each group of which the current user is a member, the group manual rating (at step 945) and the group automatic rating (at step 950) are obtained. The group automatic rating is calculated the same way as defined above for the user automatic rating.

As for the group manual rating, the value is obtained similarly to the user manual rating, with a slight adjustment. If no user belonging to the group ever rated the result, then this group is not considered for the group manual rating score. Otherwise, the group manual rating is an average of the ratings of the different users that rated the result. In order to smooth this average, an additional virtual rating is added, with a default value. Then, the average group manual rating is calculated including this virtual rating. For instance, if this result was rated by only one user in a group and that the user rated the result with a value of 5 and if the default rating is 3, the virtual rating results is an average of 4. Without this virtual rating, the result would have been 5. Thus, it takes several ratings from different users to modify the group rating from the default value.

At step 955, the average of all group manual ratings that were available is calculated and set in a variable named AverageGroupManualRating. Similarly, the average of all group automatic ratings that were available is calculated and set in a variable named AverageGroupAutomaticRating. The final rating score is calculated as follow:

$$RatingScore = UserAutomaticRatingWeight * UserAutomaticRating + GroupManualRatingWeight * AverageGroupManualRating + GroupAutomaticRatingWeight * AverageGroupAutomaticRating$$

where UserAutoRatingWeight, GroupManualRatingWeight and GroupAutomaticRatingWeight are configurable parameters that define the relative importance of UserAutomaticRating, AverageGroupManualRating, and AverageGroupAutomaticRating respectively. Then, at Step 935, traditional ranking and rating score are combined as defined above.

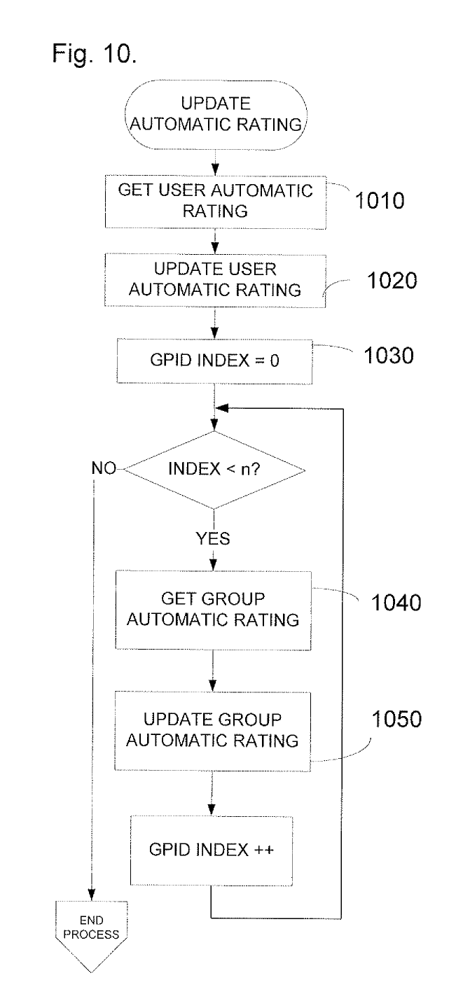

Still referring to the figures, FIG. 10 illustrates the process of updating the automatic rating database. This process is launched when a link is followed by a user (see FIG. 8, item 850) and updates the data item 725 in structure 720 from FIG. 7. Quite simply, the user automatic rating value is read at step 1010 and then updated at step 1020. The GPID index is set to “0” at step 1030. For each GPID of which the user is a member, the automatic rating value for this GPID is read at step 1040 and then updated at step 1050.

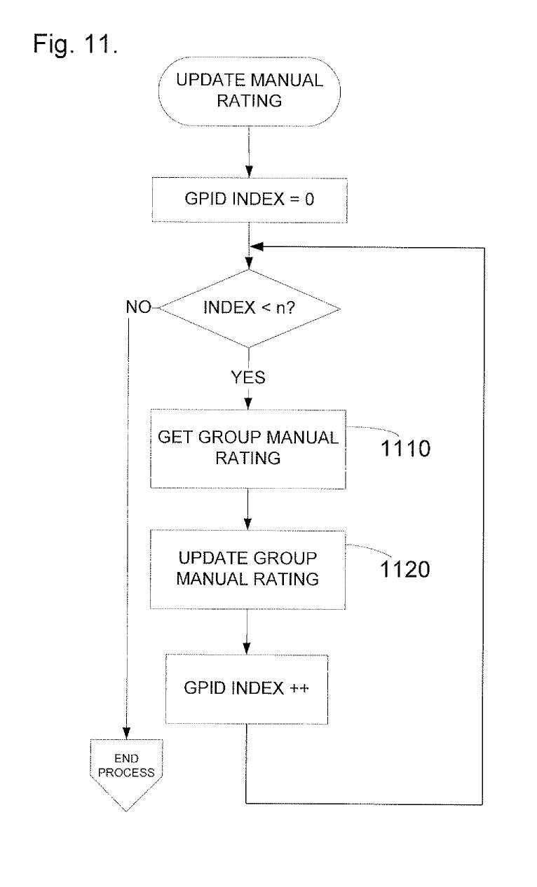

The manual rating update process works similarly, as illustrated in FIG. 11. This process updates the data items 723 and 724 of FIG. 7. For each GPID, the Group Manual rating is read at step 1110 and at step 1120, the number of manual ratings is incremented (FIG. 7, item 724) and a new average manual rating is calculated and written (FIG. 7, item 723).

While illustrated in the block diagrams as groups of discrete components communicating with each other via distinct data signal connections, it will be understood by those skilled in the art that an embodiments are provided by a combination of hardware and software components, with some components being implemented by a given function or operation of a hardware or software system, and many of the data paths illustrated being implemented by data communication within a computer application or operating system. The structure illustrated is thus provided for efficiency of teaching the present embodiment.

It should be noted that the present description is meant to encompass embodiments including a method, a system, a computer readable medium or an electrical or electro-magnetical signal.

We claim:

1. A method to personalize search results on a search engine comprising:
providing a user interface;
identifying a user accessing the user interface;
associating the identified user to a unique personalization identifier (UPID) and to a list of group personalization identifiers (GPIDs), where the GPIDs identify predefined groups of which the identified user is a member;
displaying a search engine interface on the user interface;
obtaining from the search interface a query from the user;
sending the query to the search engine to find documents matching the query;
ranking the documents matching the query in order of relevancy, where the ranking is partly based on previously calculated document ratings for the UPID of the identified user, where the ranking is further based on previously calculated document ratings for each of the GPIDs of the identified user; and
displaying the ranked documents, the ranked documents constituting ranked results.

2. The method of claim 1 further comprising:
manually assessing a rating of at least one of the ranked results and sending the manual assessment to the search engine along with the UPID and GPIDs; and
updating manual rating information for the UPID and GPIDs of the user using the manual assessment.

3. The method of claim 1, further comprising:
capturing and sending click information associated to at least one of the ranked documents to the search engine along with the UPID and GPIDs of the user; and
updating automatic rating information for the UPID and GPIDs of the user using the click information.

4. The method of claim 1, wherein previously calculated document ratings are obtained by combining a manual rating score of documents with an automatic rating score of documents.

5. The method of claim 4, wherein the automatic rating score for a given document is a combination of the UPID automatic rating and an average of GPIDs ratings.

6. The method of claim 5, wherein the average of GPIDs ratings is a combination of an average manual rating of these GPIDs and an average automatic rating of these GPIDs.

7. The method of claim 6, wherein automatic ratings are calculated by measuring the number of documents at each click level, where a click level is the number of times any user clicked on this document, each click level being associated to a rating from one to five such that all documents in the index are divided in five sets according to the quartile they belong to regarding their click-level.

8. The method of claim 1, wherein the previously calculated document ratings comprise a score based only on the manual rating of the UPID, ignoring the manual ratings of the GPIDs, if there is a manual rating for this UPID.

9. A search engine system to personalize search results comprising:
a user interface for accessing by an identified user, the identified user being associated to a unique personalization identifier (UPID) and to a list of group personalization identifiers (GPIDs), where the GPIDs identify predefined groups of which the identified user is a member;
a search engine interface for displaying on the user interface and for obtaining a query from the identified user;
a search engine for finding documents matching the query; and
a ranking engine for ranking the documents matching the query in order of relevancy, where the ranking is partly based on previously calculated document ratings for the UPID of the identified user, where the ranking is further based on previously calculated document ratings for each of the GPIDs of the identified user;
the user interface being further for displaying the ranked documents, the ranked documents constituting ranked results.

10. The search engine system of claim 9, further comprising a personalized database for storing said previously calculated document ratings for the UPID of the identified user and previously calculated document ratings for each of the GPIDs of the identified user.
